(19) United States
(12) Patent Application Publication
(10) Pub. No.: US 2010/0225611 A1
(43) Pub. Date: Sep. 9, 2010

(54) ELECTROWETTING DISPLAY DEVICES

(75) Inventors: Hsin-Hung Lee, Taipei County (TW); Yu-Hsiang Tsai, Tainan County (TW); Da-Wei Lee, Taoyuan County (TW); Kuo-Lung Lo, Taipei County (TW); Wei-Yuan Cheng, Taipei County (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, HSINCHU (TW)

(21) Appl. No.: 12/690,917

(22) Filed: Jan. 20, 2010

(30) Foreign Application Priority Data
Mar. 3, 2009 (TW) TW098106800

(51) Int. Cl. G06F 3/041; G09G 3/00; G06F 3/045; G06F 3/042; G06F 3/044; G02B 26/00

(52) U.S. Cl. 345/174; 345/173; 345/32; 345/175; 359/290

(57) ABSTRACT

Electrowetting display devices are provided. The electrowetting display includes a first substrate and an opposing second substrate with a polar fluid layer and a non-polar fluid layer interposed between the first and second substrates. A first electrode is disposed on the first substrate. A second electrode is disposed on the second substrate. A hydrophilic bank structure is disposed on the first substrate, and a reflective layer is disposed on the second substrate, wherein the first substrate of the electrowetting display serves as a display face.

### CROSS REFERENCE TO RELATED APPLICATIONS

This application is based upon and claims the benefit of priority from a prior Taiwanese Patent Application No. 098106800, filed on Mar. 3, 2009, the entire contents of which are incorporated herein by reference.

### BACKGROUND OF THE INVENTION

1. Field of the Invention

The invention relates to display devices, and in particular to reflective electrowetting display devices.

2. Description of the Related Art

Electrowetting display devices render images in accordance with electrowetting or electrocapillary. Briefly, the free surface energy (distribution area) of some fluids is changed along with electric field effects.

Conventional electrowetting display devices use hydrophobic and hydrophilic solvents (such as oil and water) in pixels as part of display structures. Bias is exerted on the electrode beneath the water layer and the hydrophobic dielectric layer, resulting in voltage difference to shrink oil ink droplets due to electrowetting phenomenon. Moreover the contraction rate of oil ink can be controlled by exerting different voltages, thereby producing grayscale effect required for high-quality display.

Furthermore, in the conventional color electrowetting display structures, the lower substrate includes electrowetting components and thin film transistor (TFT) components. Meanwhile, the upper substrate includes color filter components thereon, which is difficult to assemble because of the difficulty in controlling characteristics of oil ink and water. Thus, assembly and alignment of the TFT lower substrate and the color filter upper substrate is difficult to achieve.

Moreover, touch sensing control functions are difficult to implement in the individual display cells of conventional electrowetting display structures, because the common electrode on the water layer and hydrophilic bank structure does not form a barricade between the individual pixels. Thus, bi-stable display effects of electrowetting display structures have been disclosed, wherein a hydrophilic bank structure is elevated to contact the upper substrate and form a barricade between the individual pixels. Thus, touch sensing control functions are achieved for bi-stable electrowetting displays by adopting up-and-down or left-and-right multiple hydrophobic layers so that multiple oil ink regions are achieved.

FIG. 1 is a schematic view of a conventional touch controlled electrowetting display device. Referring to FIG. 1, a conventional stacked touch controlled electrowetting display structure includes an electrowetting display panel 10 and a touch control stylus 11. By using the touch control stylus 11 to electrically induce the polar fluid 9, handwriting effect can thus be achieved. The structure of the electrowetting display panel 10 includes a first substrate 16 and a second substrate 17 opposing to each other. Non-polar fluid 8 and polar fluid 9 are interposed between the first substrate 16 and the second substrate 17. A color filter reflective layer 1 is disposed underlying the second substrate 17, as shown in FIG. 1.

FIG. 2 is a schematic cross section of a conventional single-layered color electrowetting display device. Referring to FIG. 2, a conventional single-layered color electrowetting display 20 includes a first substrate with a color filter 21 thereon and a second substrate with a reflective electrowetting structure 24 thereon. The first substrate and the second substrate are opposing to each other. A hydrophilic bank structure 27 is disposed on the reflective electrowetting structure 24, thereby defining an array of a plurality of pixels. Black dye containing a first fluid 23 is disposed on patterned electrodes of each sub-pixel region. A transparent second fluid 22 is filled between the first substrate and the second substrate. Electrical fields generated between common electrodes and localized electrodes of each pixel are exerted to change surface tension of the second fluid 22, thereby rendering displayed images. More specifically, by controlling shrinkage or spread of the black non-polar oil ink to reflect or absorb ambient incident light and by using reflective light passing through the color filter on the upper substrate, various colored lights can thus be generated to achieve full color display.

### BRIEF SUMMARY OF THE INVENTION

An embodiment of the invention provides an electrowetting display device, comprising: a first substrate and an opposing second substrate with a polar fluid layer and a non-polar fluid layer interposed therebetween, wherein the non-polar fluid layer contacts the first substrate; a first electrode disposed on the first substrate; a second electrode disposed on the second substrate; a hydrophilic bank structure disposed on the first substrate; and a reflective layer disposed on the second substrate, wherein the first substrate of the electrowetting display serves as a display face.

Another embodiment of the invention provides an electrowetting display device, comprising: an electrowetting display device, comprising: a first substrate and an opposing second substrate with a polar fluid layer and a non-polar fluid layer interposed therebetween, wherein the non-polar fluid layer contacts the first substrate; a first electrode disposed on the first substrate; a second electrode disposed on the second substrate; a hydrophilic bank structure disposed on the first substrate; and an absorption layer disposed on the second substrate, wherein the first substrate of the electrowetting display serves as a display face.

Another embodiment of the invention provides an electrowetting display device, comprising: a first substrate and an opposing second substrate with a polar fluid layer and a non-polar fluid layer interposed therebetween, wherein the non-polar fluid layer contacts the first substrate; a first electrode disposed on the first substrate; a second electrode disposed on the second substrate; a hydrophilic bank structure disposed on the first substrate; a touch sensing device disposed on the first substrate; and a reflective layer disposed on the second substrate, wherein the first substrate of the electrowetting display serves as a display face.

Another embodiment of the invention provides an electrowetting display device, comprising: a first substrate and an opposing second substrate with a white polar fluid layer and a black non-polar fluid layer interposed therebetween, wherein the black non-polar fluid layer contacts the first substrate; a first electrode disposed on the first substrate; a second electrode disposed on the second substrate; and a hydrophilic bank structure disposed on the first substrate, wherein the first substrate of the electrowetting display serves as a display face.

### BRIEF DESCRIPTION OF THE DRAWINGS

The invention can be more fully understood by reading the subsequent detailed description and examples with references made to the accompanying drawings, wherein:

FIG. 1 is a schematic view of a conventional touch controlled electrowetting display device;

FIG. 2 is a schematic cross section of a conventional single-layered color electrowetting display device;

FIG. 3 is a schematic cross section of an embodiment of the electrowetting display device 100a of the invention;

FIG. 4 is a schematic cross section of another embodiment of the electrowetting display device 100b of the invention;

FIG. 5 is a schematic cross section of another embodiment of the electrowetting display device 100c of the invention;

FIG. 6 is a schematic cross section of another embodiment of the electrowetting display device 100d of the invention;

FIG. 7 is a schematic cross section of another embodiment of the electrowetting display device 100e of the invention;

FIG. 8 is a schematic cross section of another embodiment of the electrowetting display device 100f of the invention;

FIG. 9 is a schematic cross section of another embodiment of the electrowetting display device 100g of the invention;

FIGS. 10A-10C are schematic cross sections illustrating comparisons between conventional and various embodiments of the electrowetting display structures;

FIG. 11 is a schematic cross section of another embodiment of the electrowetting display device 100h of the invention; and

FIGS. 12A-12C are schematic cross sections illustrating comparisons among various embodiments of the electrowetting display structures.

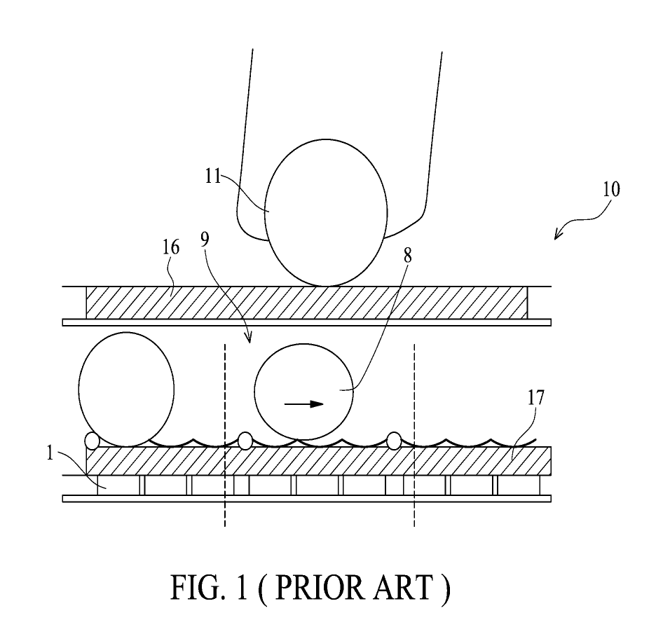

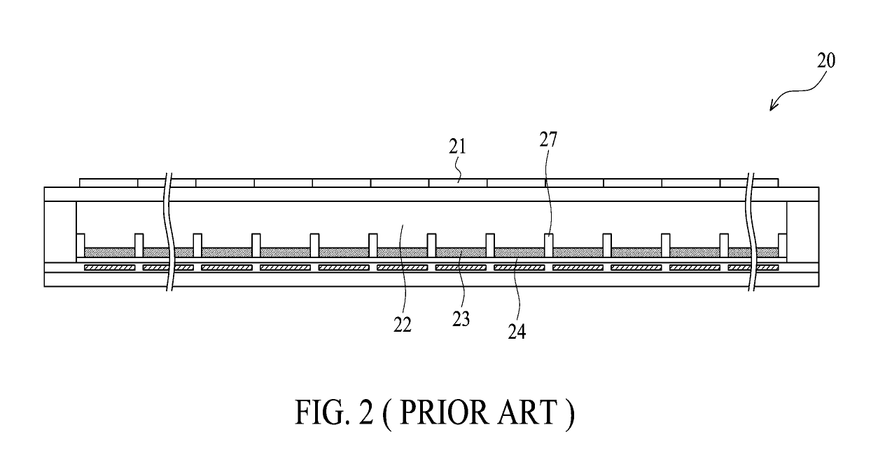

### DETAILED DESCRIPTION OF THE INVENTION

It is to be understood that the following disclosure provides many different embodiments, or examples, for implementing different features of various embodiments. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself indicate a relationship between the various embodiments and/or configurations discussed. Moreover, the formation of a first feature over or on a second feature in the description that follows may include embodiments in which the first and second features are formed in direct contact or not in direct contact.

Some embodiments of the invention provide various electrowetting display structures. The electrowetting display panel is entirely reverse-disposed. An in-cell touch sensing control technique is selectively adapted to the electrowetting display structures preventing oil ink from blocking sensing light intensity such that the electrowetting display device is equipped with touch control and display functions. Because the electrowetting display device is equipped with a high resolution panel, the reversed electrowetting display is advantageous due to a simpler fabrication process. By reversely disposing the pixel structures of the electrowetting display and by selectively adopting the in-cell touch sensing control technique and color filter, the electrowetting display device can be equipped with handwriting, touch control and full color display functions. Furthermore, the reversed electrowetting display structures are more suitable for flexible display applications.

In order to integrate the electrowetting display with handwriting touch control functions, embodiments of the invention adopt photo-detectors in the pixel regions. However, if the photo-detectors are formed on the lower substrate of the reflective electrowetting display, erroneous detection signals may be generated due to coverage by the oil ink. On the other hand, if the detectors are formed on the upper substrate of the reflective electrowetting display, additional connection circuits are needed to couple signals on the upper substrates to the lower substrates. Thus, make the fabrication process more complex due to the additional alignment procedures of the upper and the lower substrates.

Given the above, according to some embodiments of the invention, the electrowetting display structure is reversely disposed. Therefore, the reflective layer is formed on the common electrode substrate, i.e., the electrowetting display structure is formed on the upper substrate. During fabrication of the patterned pixel electrodes, the photo-detector components are formed on the upper substrate. Because the transparent substrate will not affect operation of the touch control panel, a touch control electrowetting display can be achieved.

In addition, the upper electrowetting display structure substrate can further be assembled with color filters, incorporating various colors of polar and non-polar fluids to achieve full color display. Meanwhile, since alignment concerns are eliminated (the lower substrate has common electrodes including an absorption layer or a reflective layer) during assembly of the upper and the lower substrates, the spacing between the color filters and the fluid light switch in the electrowetting display structure of the invention can be reduced, thus ameliorating limitations of color cast and narrow viewing angles for conventional electrowetting display structures.

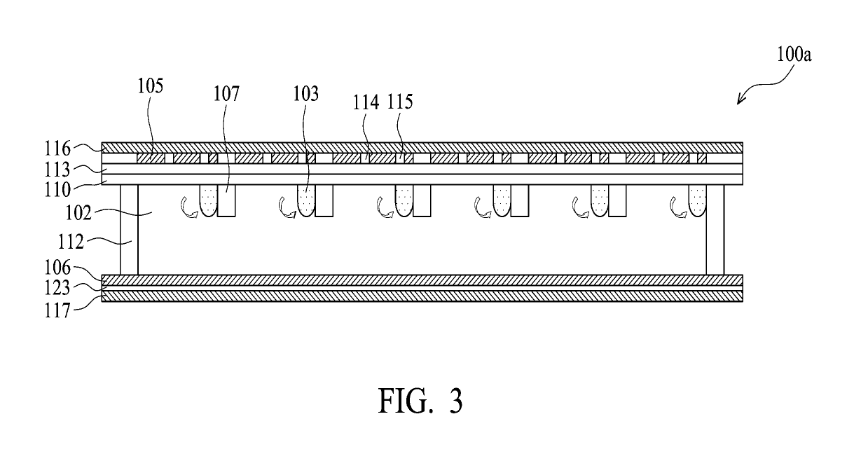

FIG. 3 is a schematic cross section of an embodiment of the electrowetting display device 100a of the invention. Referring to FIG. 3, the electrowetting display device 100a includes a first substrate 116 and a second substrate 117 opposing to each other. A polar fluid layer 102 (such as water) and a non-polar fluid layer 103 (such as black oil droplets) are interposed between the first and second substrates, wherein the non-polar fluid layer contacts the first substrate. A first electrode 105 is disposed on the first substrate 116. A second electrode 106 is disposed on the second substrate 117. A hydrophilic bank structure 107 is disposed on the first substrate 116. A reflective layer 123 is disposed on the second substrate 117, wherein the first substrate of the electrowetting display serves as a display face. A blocking layer 113 and a hydrophobic layer 110 are disposed on the first substrate 116. An outer bank structure 112 disposed on the peripheral area of the electrowetting display. A thin film transistor array 114 and a photo-detector 115 are disposed on the first substrate 116 and on the same layer with first electrode 115. Alternatively, in one embodiment, the electrowetting display device is equipped with a touch sensing control device including a thin film transistor array and a photo-detector, wherein the thin film transistor includes an amorphous silicon thin film transistor or a polysilicon thin film transistor. In another embodiment, the sensor element comprises a photo-detector, a resistive sensor, or a capacitance sensor. The detected wavelength of the photo-detector is approximately in a range of 0.3-1.1 μm. Moreover, the touch sensing device is embedded within a thin film transistor array of the first substrate, and the sensor element includes a photo-detector, a resistive sensor, or a capacitance sensor.

The first substrate 116 and the second substrate 117 can be made of rigid glass substrates or flexible polymer substrates. The first and the second electrodes 105 and 106 can be transparent electrodes comprising indium tin oxide (ITO) or indium zinc oxide (IZO). Note that the structure of the first electrode comprises a rectangular structure, a square structure, a triangular structure, a circular structure, a trapezoid structure, or an elliptic structure. The polar fluid 102 comprises a colorless, a white, or a reflective substance containing solution. The non-polar fluid 103 comprises a color solution. For example, the non-polar fluid layer 103 can be made of decane, dodecane, or tetradecane. The opaque non-polar fluid layer 103 includes black dye or black pigment. In one embodiment, different pixels in the pixel array are corresponding to different colors.

The blocking layer 113 is made of parylene, silicon oxide (SiOₓ), silicon nitride (SiNₓ), poly (vinyldiene fluoride)), lead zirconate titanate (PZT), or barium strontium titanate (BST). Note that, in another embodiment, the electrowetting display device further includes a dielectric layer disposed on the first electrode. In another embodiment, the electrowetting display device further includes a hydrophobic layer disposed on the dielectric layer. In addition, in another embodiment, an absorption layer is alternatively disposed on the second substrate, wherein the absorption OD value of the absorption layer is approximately greater than 1.

In FIG. 3, the main electrowetting display components are fabricated on the first substrate of the electrowetting display device 100a which includes active thin film transistors, pixel electrode patterns, photo-detectors, and deposition of the blocking layer and application of the hydrophobic layer. The pixel structures of the electrowetting display are fabricated on the hydrophobic layer. A reflective layer and a conductive layer are formed on the second substrate. The polar fluid and black non-polar fluid are interposed between the first substrate and the second substrate. Alignment and assembly are sequentially performed. Therefore, the first substrate is formed with a reversed electrowetting display structure and a touch control panel structure, while the second substrate is formed with a reflective layer and a common conductive layer.

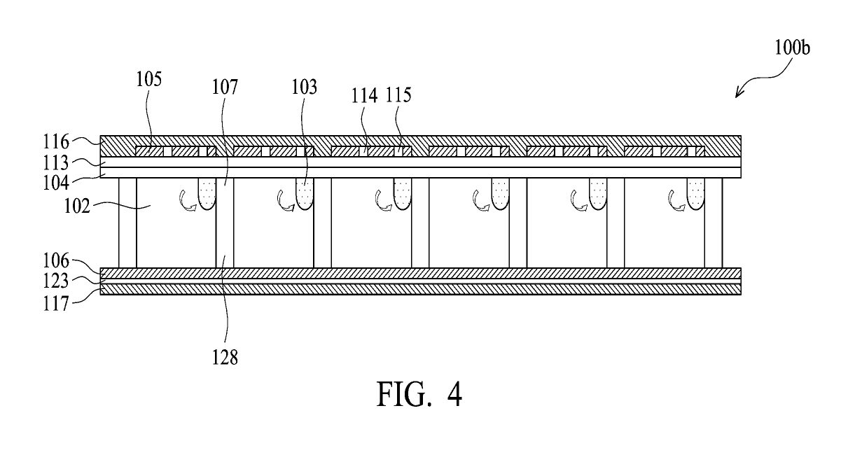

FIG. 4 is a schematic cross section of another embodiment of the electrowetting display device 100b of the invention. Referring to FIG. 4, the electrowetting display device 100b is nearly identical to the electrowetting display device 100a of the previous embodiment in FIG. 3 and for simplicity its detailed description is omitted. The electrowetting display device 100b is different from the electrowetting display device 100a in that the hydrophilic bank structure 107 has an extension structure 128 which extends from the first substrate 116 to the second substrate 117.

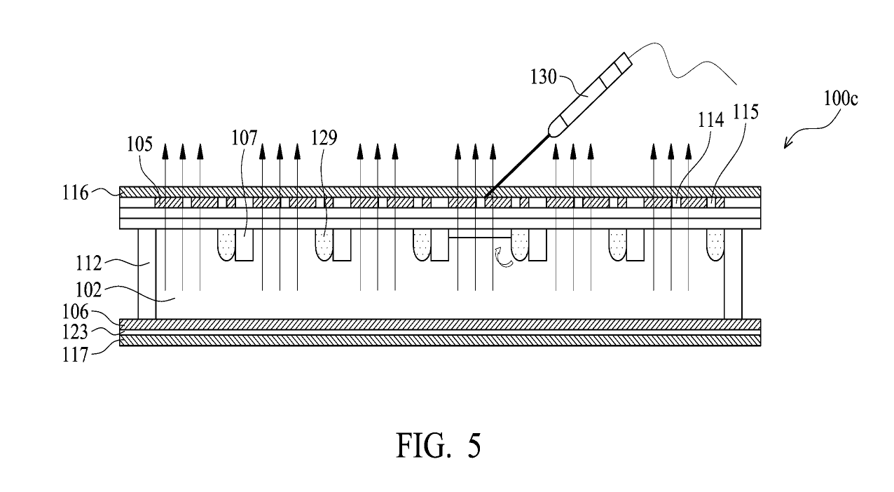

FIG. 5 is a schematic cross section of another embodiment of the electrowetting display device 100c of the invention. The electrowetting display device 100c is nearly identical to the electrowetting display device 100a of the previous embodiment in FIG. 3 and for simplicity its detailed description is omitted. The electrowetting display device 100c is different from the electrowetting display device 100a in that the non-polar fluid layer contains a color non-polar solution 129 and an optical input apparatus 130 is used to touch-control the photo-detector 115 to implement handwriting purpose.

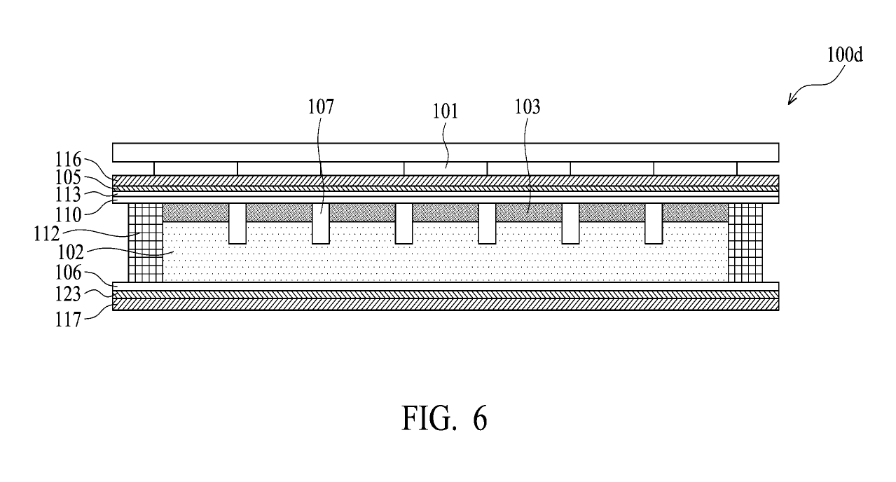

FIG. 6 is a schematic cross section of another embodiment of the electrowetting display device 100d of the invention. The electrowetting display device 100d is nearly identical to the electrowetting display device 100a of the previous embodiment in FIG. 3 and for simplicity its detailed description is omitted. The electrowetting display device 100d is different from the electrowetting display device 100a in that a color filter 101 is disposed on the display face of the first substrate 116.

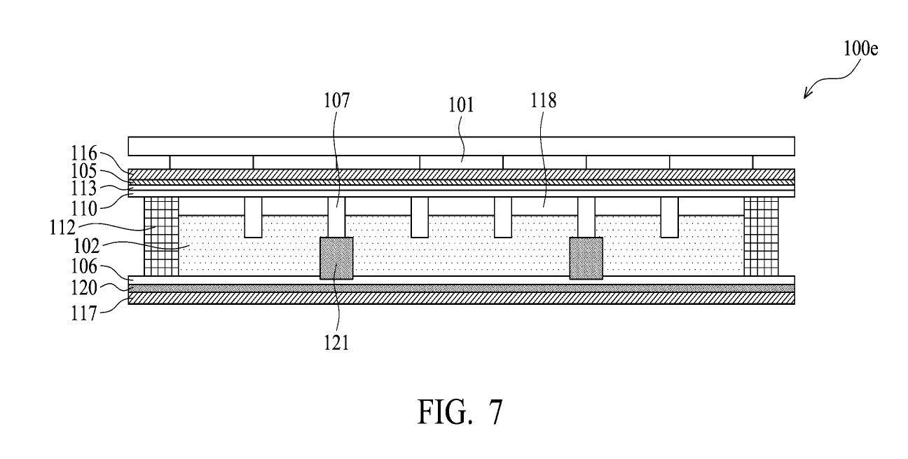

FIG. 7 is a schematic cross section of another embodiment of the electrowetting display device 100e of the invention. The electrowetting display device 100e is nearly identical to the electrowetting display device 100a of the previous embodiment in FIG. 3 and for simplicity its detailed description is omitted. The electrowetting display device 100e is different from the electrowetting display device 100a in that a color filter 101 is disposed on the display face of the first substrate 116. Part of the hydrophilic bank structure 107 is connected to a hydrophilic extension component 121 supporting the spacing between the first substrate and the second substrate. In FIG. 7, the main electrowetting display components of the electrowetting display device 100e are disposed on the first substrate, while the color filter is disposed in opposite side of the same substrate. The electrowetting display device 100e has advantage in which the electrowetting display components can be formed in advance, and then the color filter can be aligned and assembled on the opposite side of the same substrate. The non-polar fluid 118 can be white oil droplets. A black absorption layer can be formed on the substrate opposing the electrowetting display components. Note that the hydrophilic bank structure can be formed between the first and the second substrates for fixing the spacing between the upper and lower substrates of the flexible display. In one embodiment, colors of the white polar fluid and the black non-polar fluid are interchangeable.

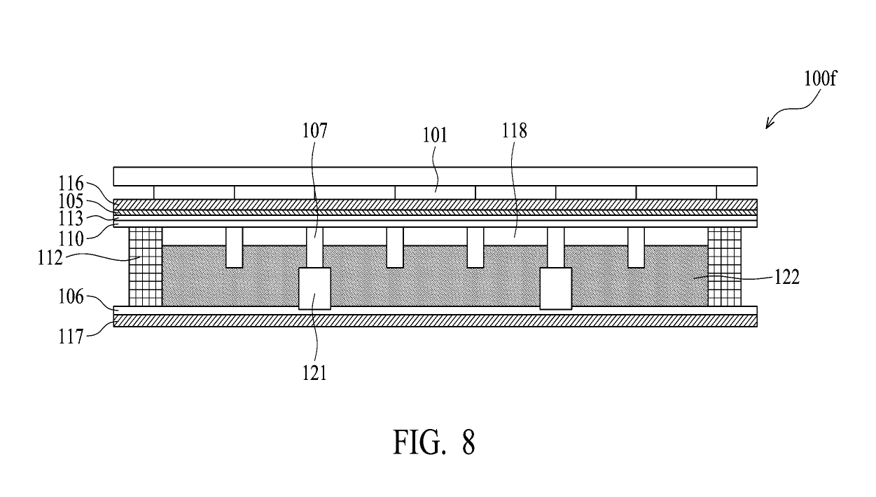

FIG. 8 is a schematic cross section of another embodiment of the electrowetting display device 100f of the invention. The electrowetting display device 100f of FIG. 8 is nearly identical to the electrowetting display device 100a of the previous embodiment in FIG. 3 and for simplicity its detailed description is omitted. The electrowetting display device 100f is different from the electrowetting display device 100a in that the non-polar fluid 118 can be a white solution or a reflective substance containing solution, while the polar fluid 122 can be a black polar solution. In this embodiment, the electrowetting display device 100f adopts a black polar solution to replace the transparent polar solution.

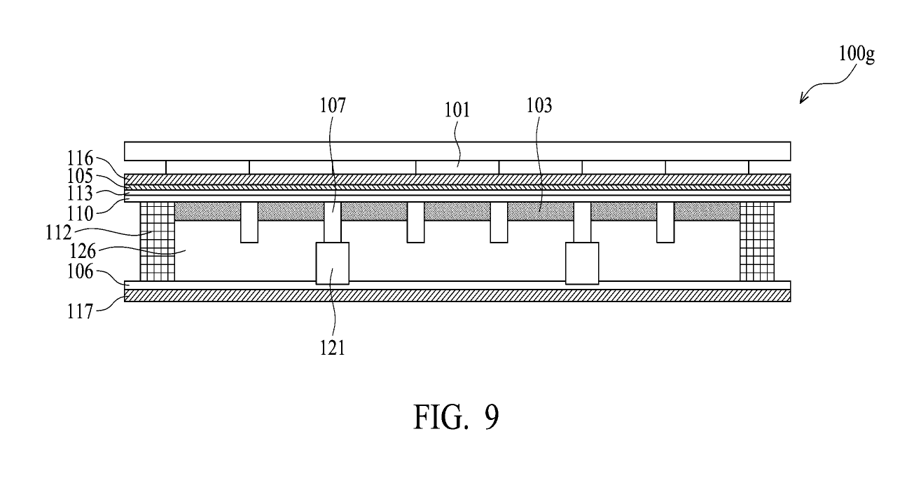

FIG. 9 is a schematic cross section of another embodiment of the electrowetting display device 100g of the invention. The electrowetting display device 100g of FIG. 9 is nearly identical to the electrowetting display device 100f of the previous embodiment in FIG. 8 and for simplicity its detailed description is omitted. The electrowetting display device 100g is different from the electrowetting display device 100f in that the non-polar fluid layer 103 can include a black absorption substances containing droplets, while the polar fluid layer 126 can include a colorless solution or a black absorption substances containing polar solution.

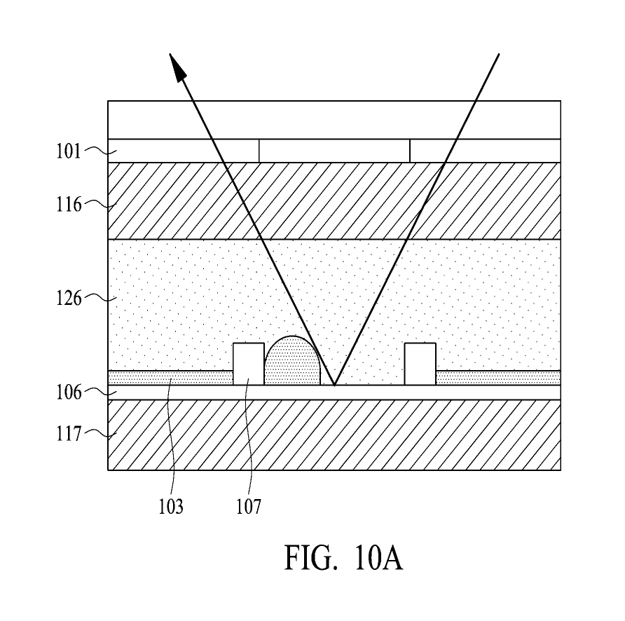

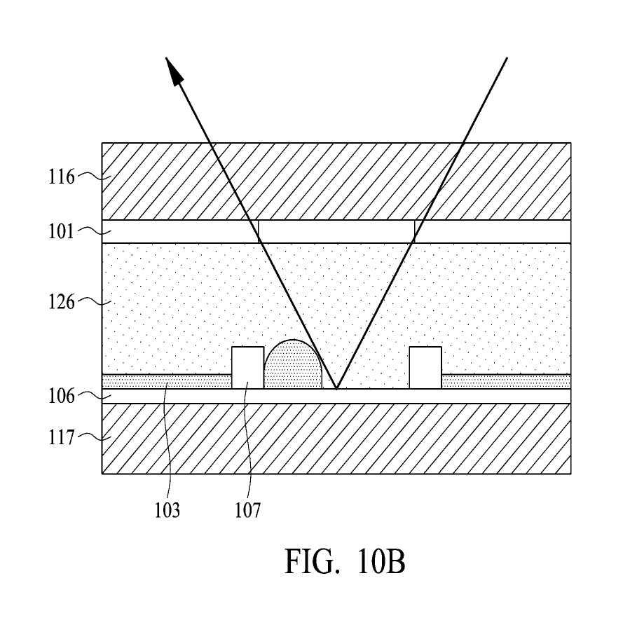

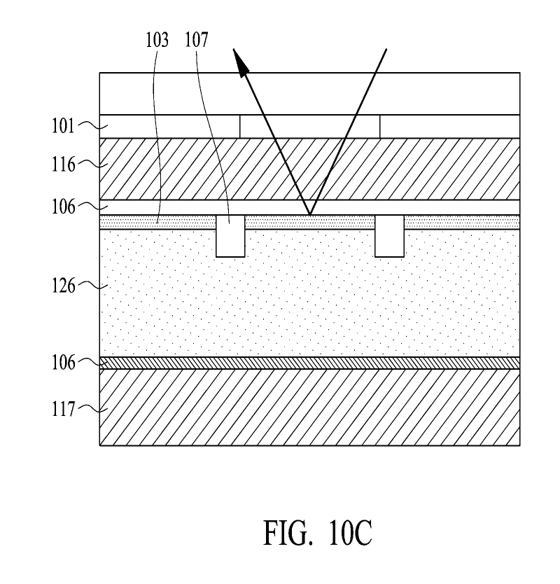

FIGS. 10A-10C are schematic cross sections illustrating comparisons between conventional and various embodiments of the electrowetting display structures. FIG. 10A shows a color filter attached on the outer surface of the conventional electrowetting display structure. The electrowetting light switch is far away from the color filter, resulting in smaller viewing angles which are prone to having color cast phenomenon. FIG. 10B shows a color filter that is directly assembled with the lower substrate with electrowetting display components of another conventional electrowetting display structure. Since the behaviors of the oil and water are difficult to control, alignment and assembly processes are difficult. FIG. 10C shows an embodiment of the electrowetting display structure of the invention. The spacing between the electrowetting light switch and the color filter is reduced, therefore resulting in wider viewing angles and prevention of color cast phenomenon. Also, alignment and assembly processes are simplified.

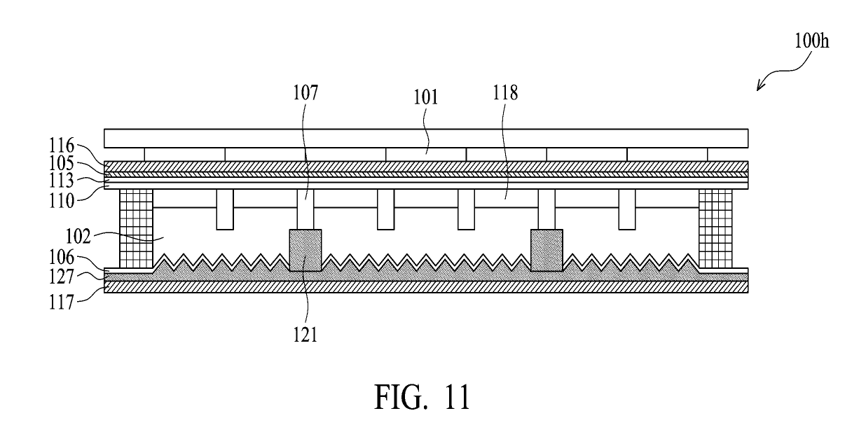

FIG. 11 is a schematic cross section of another embodiment of the electrowetting display device 100h of the invention. The electrowetting display device 100h of FIG. 11 is nearly identical to the electrowetting display device 100e of the previous embodiment in FIG. 7 and for simplicity its detailed description is omitted. The electrowetting display device 100h is different from the electrowetting display device 100e in that the reflective layer is a micro-mirror reflective plate structure 127. A reflectance of the reflective layer equals to or is in excess of about 50%, and the reflective layer has a transparent hole or a micro-structural minor thereon. The micro-structural minor can comprise an array of triangular cones, triangular polyhedron cones, triangular grooves, trapezoidal cones, trapezoidal polyhedron cones, or trapezoidal grooves. Alternatively or optionally, the micro-structural mirror has a mirror tilt angle with a range approximately between 40° and 65°.

In FIG. 11, the main electrowetting display components of the electrowetting display device 100h are disposed on the first substrate, while the color filter is formed on the opposite side of the same substrate. The micro-structural minor serves as reflective face on the opposing substrate. Therefore, the electrowetting display device 100h is advantageous in having wider viewing angles, preventing color cast phenomenon, and having simpler alignment and assembly processes.

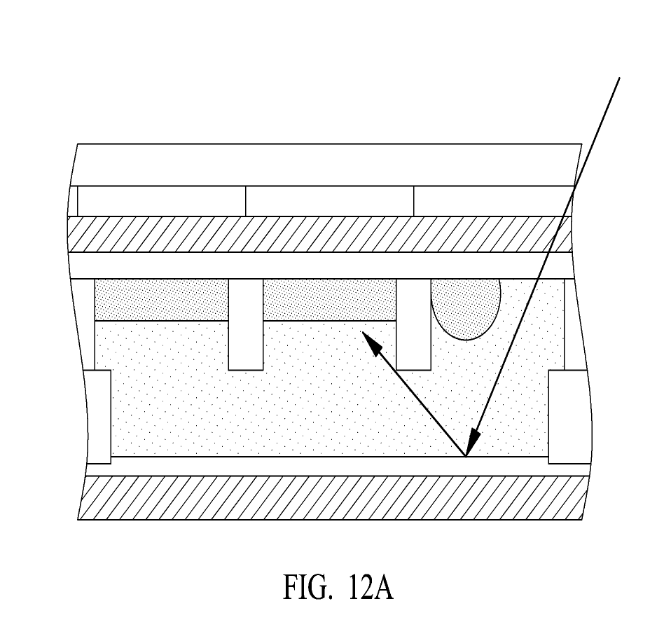

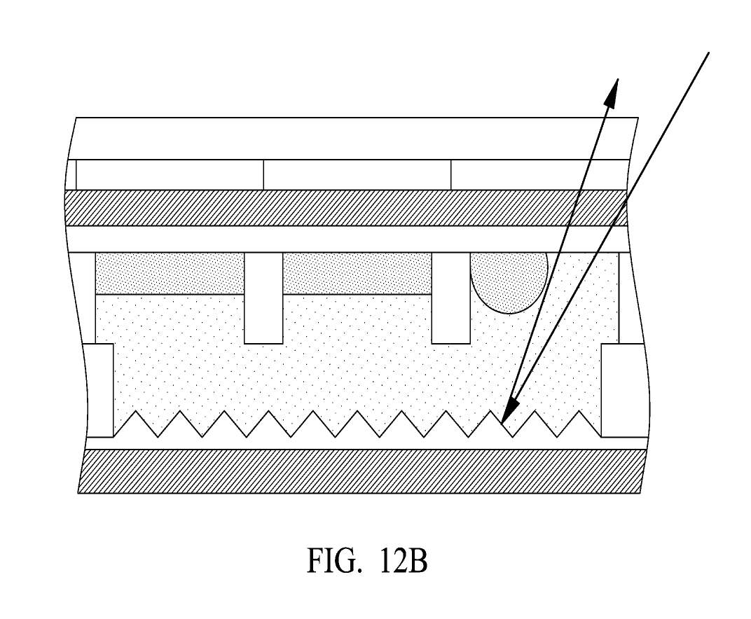

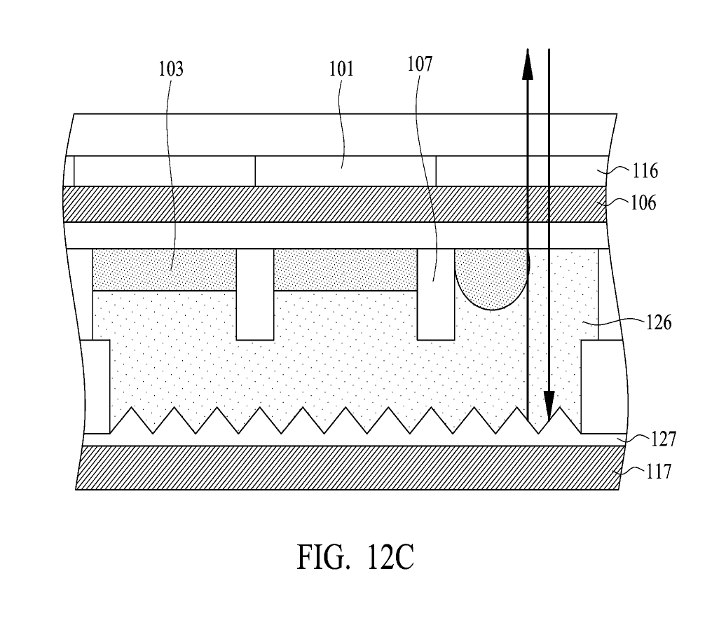

FIGS. 12A-12C are schematic cross sections illustrating comparisons among various embodiments of the electrowetting display structures. FIG. 12A shows a color filter attached on the outer surface of the conventional electrowetting display structure in which black oil ink and water serve as display media, resulting in the structure being prone to having color cast phenomenon. FIG. 12B shows an embodiment of the electrowetting display structure of the invention. The micro-structural mirror reflective plate is assembled on the opposite side of the electrowetting display components and the color filter, thereby widening viewing angles, preventing color cast phenomenon, and improving optical usage. FIG. 12C shows another embodiment of the electrowetting display structure of the invention. The micro-structural mirror reflective plate is assembled on the opposite side of the electrowetting display components and the color filter in which the micro-structural mirror is tilted about 45°. When ambient light is normally incident into the electrowetting display structure, a normal reflected light is output. Moreover, the dimensions of the micro-structural mirror are smaller than those of the pixel structure. Also, alignment and assembly issues are eliminated, resulting in simpler processes.

While the invention has been described by way of example and in terms of the several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrowetting display device, comprising:
a first substrate and an opposing second substrate with a polar fluid layer and a non-polar fluid layer interposed therebetween, wherein the non-polar fluid layer contacts the first substrate;
a first electrode disposed on the first substrate;
a second electrode disposed on the second substrate;
a hydrophilic bank structure disposed on the first substrate; and
a reflective layer disposed on the second substrate,
wherein the first substrate of the electrowetting display serves as a display face.

2. The electrowetting display device as claimed in claim 1, wherein the polar fluid comprises a colorless, a white, or a reflective substance containing solution.

3. The electrowetting display device as claimed in claim 1, wherein the non-polar fluid comprises a color solution.

4. The electrowetting display device as claimed in claim 1, wherein the first electrode comprises a rectangular structure, a square structure, a triangular structure, a circular structure, a trapezoid structure, or an elliptic structure.

5. The electrowetting display device as claimed in claim 1, further comprising a dielectric layer disposed on the first electrode.

6. The electrowetting display device as claimed in claim 5, further comprising a hydrophobic layer disposed on the dielectric layer.

7. The electrowetting display device as claimed in claim 1, wherein the hydrophilic bank structure extends or is attached to the second substrate.

8. The electrowetting display device as claimed in claim 1, wherein the first substrate is a color filter substrate.

9. The electrowetting display device as claimed in claim 1, wherein a reflectance of the reflective layer equals to or is in excess of about 50%, and the reflective layer has a transparent hole or a micro-structural mirror thereon.

10. The electrowetting display device as claimed in claim 9, wherein the micro-structural mirror comprises an array of triangular cones, triangular polyhedron cones, triangular grooves, trapezoidal cones, trapezoidal polyhedron cones, or trapezoidal grooves.

11. The electrowetting display device as claimed in claim 9, wherein the micro-structural mirror has a minor tilt angle with a range approximately between 40° and 65°.

12. An electrowetting display device, comprising:
a first substrate and an opposing second substrate with a polar fluid layer and a non-polar fluid layer interposed therebetween, wherein the non-polar fluid layer contacts the first substrate;
a first electrode disposed on the first substrate;
a second electrode disposed on the second substrate;
a hydrophilic bank structure disposed on the first substrate; and
an absorption layer disposed on the second substrate,
wherein the first substrate of the electrowetting display serves as a display face.

13. The electrowetting display device as claimed in claim 12, wherein the polar fluid comprises a colorless solution or a black solution.

14. The electrowetting display device as claimed in claim 12, wherein the non-polar fluid comprises a white solution or a reflective substance containing solution.

15. The electrowetting display device as claimed in claim 12, wherein the first electrode comprises a rectangular structure, a square structure, a triangular structure, a circular structure, a trapezoid structure, or an elliptic structure.

16. The electrowetting display device as claimed in claim 12, further comprising a dielectric layer disposed on the first electrode.

17. The electrowetting display device as claimed in claim 16, further comprising a hydrophobic layer disposed on the dielectric layer.

18. The electrowetting display device as claimed in claim 12, wherein the hydrophilic bank structure extends or is attached to the second substrate.

19. The electrowetting display device as claimed in claim 12, wherein the first substrate is configured with a touch sensing device.

20. The electrowetting display device as claimed in claim 19, wherein the touch sensing device comprises an array of thin film transistors and a sensor element.

21. The electrowetting display device as claimed in claim 20, wherein the thin film transistor comprises an amorphous silicon thin film transistor or a polysilicon thin film transistor.

22. The electrowetting display device as claimed in claim 20, wherein the sensor element comprises a photo-detector, a resistive sensor, or a capacitance sensor.

23. The electrowetting display device as claimed in claim 22, wherein the detected wavelength of the photo-detector is approximately in a range of 0.3-1.1 μm.

24. The electrowetting display device as claimed in claim 12, wherein the first substrate is a color filter substrate.

25. The electrowetting display device as claimed in claim 12, wherein the absorption OD value of the absorption layer is approximately greater than 1.

26. An electrowetting display device, comprising:
a first substrate and an opposing second substrate with a polar fluid layer and a non-polar fluid layer interposed therebetween, wherein the non-polar fluid layer contacts the first substrate;
a first electrode disposed on the first substrate;
a second electrode disposed on the second substrate;
a hydrophilic bank structure disposed on the first substrate;
a touch sensing device disposed on the first substrate; and
a reflective layer disposed on the second substrate,
wherein the first substrate of the electrowetting display serves as a display face.

27. The electrowetting display device as claimed in claim 26, wherein the polar fluid comprises a colorless, a white, or a reflective substance containing solution.

28. The electrowetting display device as claimed in claim 26, wherein the non-polar fluid comprises a color solution.

29. The electrowetting display device as claimed in claim 26, further comprising a dielectric layer disposed on the first electrode.

30. The electrowetting display device as claimed in claim 29, further comprising a hydrophobic layer disposed on the dielectric layer.

31. The electrowetting display device as claimed in claim 26, wherein the hydrophilic bank structure extends or is attached to the second substrate.

32. The electrowetting display device as claimed in claim 26, wherein the hydrophilic bank structure is arranged as a pixel array which shape comprises a rectangular structure, a square structure, a triangular structure, a circular structure or an elliptic structure.

33. The electrowetting display device as claimed in claim 32, wherein different pixels in the pixel array are corresponding to different colors.

34. The electrowetting display device as claimed in claim 26, wherein the touch sensing device comprises an array of thin film transistors and a sensor element.

35. The electrowetting display device as claimed in claim 34, wherein the thin film transistor comprises an amorphous silicon thin film transistor or a polysilicon thin film transistor.

36. The electrowetting display device as claimed in claim 34, wherein the sensor element comprises a photo-detector, a resistive sensor, or a capacitance sensor.

37. The electrowetting display device as claimed in claim 36, wherein the detected wavelength of the photo-detector is approximately in a range of 0.3-1.1 μm.

38. The electrowetting display device as claimed in claim 26, wherein a reflectance of the reflective layer equals to or is in excess of about 50%, and the reflective layer has a transparent hole or a micro-structural mirror thereon.

39. The electrowetting display device as claimed in claim 38, wherein the micro-structural mirror comprises an array of triangular cones, triangular polyhedron cones, triangular grooves, trapezoidal cones, trapezoidal polyhedron cones, or trapezoidal grooves.

40. The electrowetting display device as claimed in claim 38, wherein the micro-structural mirror has a minor tilt angle with a range approximately between 40° and 65°.

41. An electrowetting display device, comprising:
a first substrate and an opposing second substrate with a white polar fluid layer and a black non-polar fluid layer interposed therebetween, wherein the black non-polar fluid layer contacts the first substrate;
a first electrode disposed on the first substrate;
a second electrode disposed on the second substrate; and
a hydrophilic bank structure disposed on the first substrate,
wherein the first substrate of the electrowetting display serves as a display face.

42. The electrowetting display device as claimed in claim 41, wherein the white polar fluid comprises a reflective substance containing solution.

43. The electrowetting display device as claimed in claim 41, wherein colors of the white polar fluid and the black non-polar fluid are interchangeable.

44. The electrowetting display device as claimed in claim 41, further comprising a dielectric layer disposed on the first electrode.

45. The electrowetting display device as claimed in claim 44, further comprising a hydrophobic layer disposed on the dielectric layer.

46. The electrowetting display device as claimed in claim 41, wherein the hydrophilic bank structure extends or is attached to the second substrate.

47. The electrowetting display device as claimed in claim 41, wherein the first substrate is configured with a touch sensing device.

48. The electrowetting display device as claimed in claim 47, wherein the touch sensing device is embedded within a thin film transistor array of the first substrate, and wherein the touch sensing device comprises a photo-detector, a resistive sensor, or a capacitance sensor.

49. The electrowetting display device as claimed in claim 41, wherein the first substrate is a color filter substrate.
